(19) United States
(12) Patent Application Publication
(10) Pub. No.: US 2012/0021882 A1
(43) Pub. Date: Jan. 26, 2012

(54) PIN AND DOUBLE PROFILE ROLL ASSEMBLY

(76) Inventor: LeRoy J. Reiner, San Jose, CA (US)

(21) Appl. No.: 13/190,375

(22) Filed: Jul. 25, 2011

Related U.S. Application Data
(60) Provisional application No. 61/367,273, filed on Jul. 23, 2010.

(51) Int. Cl. F16C 13/00

(52) U.S. Cl. 492/47

(57) ABSTRACT

A pin and double roll assembly, in which mounted on the pin are a horizontal thrust bearing and a vertical roller bearing. Mounted over the roller bearing is a double sided seaming roll. A cap over the roller bearing and retained against the double sided seaming roll and retained by a screw holds the parts in relation to each other. The thrust bearing and the roller bearing allow the double sided seaming roll to rotate on the pin during use. A sealing ring between a lip on the pin and the double sided seaming roll seals the part such that water or corrosive liquids cannot reach the thrust bearing or roller bearing as the part is used.

### CROSS-REFERENCE TO RELATED APPLICATION

The present application claims priority from U.S. Provisional Patent Application Ser. No. 61/367,273 filed Jul. 23, 2010.

### TECHNICAL FIELD

The present invention relates to machine parts used in canning and more specifically to can sealing rollers.

### BACKGROUND

In production of canned food, specialized tools are required for sealing tops onto cans. Typically a cylindrical can has a bottom attached to the vertical walls, the can is filled (e.g. with a liquid) and the can is then sealed. A chuck is used to bring an end disc (e.g. the bottom and top) to the cylindrical walls to construct the can. Specialized roll assemblies (can seamer tooling) are used to crimp the edge of an end disc, forming the closed end of the can. For example, the Trimac System can seamer tooling (Trimac Manufacturing Inc., Santa Clara Calif.) has been designed to be used on Angelus “P” Style seaming machines. These seal 603 size cans, which are used for a variety of food products (e.g. tomatoes, fruit, etc.)

One standard roll assembly part used to create this crimped end-section is shown in FIG. 1. A roll assembly includes a pin 9. This pin has a threaded mount 9a allowing attachment onto a seaming machine. The part is attached such that cylindrical projection 9c extends downward. On pin 9, a flat, annular platform 9b holds a thrust bearing 8. Positioned against the trust bearing is a roller assembly 21. This is comprised of a double groove seaming roll 5. Internally fit within seaming roll 5 on each end are bearings 4, 6. These are held in place by retaining rings 3, 7. Once these rings are in place, removal is very difficult. Because removal is so difficult, roller assembly 21 is commonly treated as a single part. Rather than remove and repair parts on roller assembly 21, is any component is damaged or shows degraded performance, the part is simply replaced. Alternatively, the entire pin assembly (all parts of FIG. 1) could simply be replaced.

The roller assembly 21 fits over the projection 9c. A grease hole 9e provides grease, from the interior of projection 9c, to the roller assembly 21. The part rotates on thrust bearing 8. A thrust plate 2 is secured over the roller assembly 21 by flat head screw 1. Flat head screw 1 is secured into internal threads 9d on projection 9c.

This type of roll assembly is currently in widespread use. However there are a number of issues realized in the use of this part. These include:

1. To prevent the flat head screw 1 from backing out as the tool is in use, the thrust plate 2 includes a pin (not shown, on reverse side) that fits into hole 9f on pin 9. However, given the positioning of pin 9 on a seamer, locating the thrust plate is awkward and may be time consuming. When the pin is in place on a can sealing machine, projection 9c faces down, pointing at the can assembly line. A machinist will thus not have a view of the hole 9f when positioning on the thrust plate.
2. The greasing ideally should provide grease to both the thrust bearing 8, and the bearings 4 and 6. However the placement of grease hole 9e commonly provides insufficient grease to thrust bearing 8. The movement and positioning of the part drives the grease outward from hole 9e and downward from this hole, through the roller assembly 21. This is not ideal for getting grease to thrust bearing 8. In addition the retaining ring 7 tends to act as a grease barrier, further preventing grease from reaching thrust bearing 8. Without sufficient grease, thrust bearing 8 will operate less efficiently, and will wear. It is also more likely to corrode if spilled food or wash liquid contacts this part if it is not greased.
3. Because this tool is used on food products, it must be periodically washed. When washed, if water is retained on the parts, they can rust. The grease acts to inhibit the rust by coating parts. However the thrust bearing has rollers that trap water, resulting in this part rusting. The rust also may degrade the pin. Both parts would then need to be replaced. If such wear is seen, most commonly the entire part will be replaced.
4. The length of the flat head screw is limited, because the screw must not block the grease hole 9e, which channels grease from the interior of the pin.
5. To change the bearings 4 and 6 requires removal of the retaining rings 3, 7 respectively. This requires a hydraulic press with special tooling to change these roller bearing. Commonly, the user will simply discard the entire roller assembly 21, or the entire seamer part shown in FIG. 1. While this may save time, it is inefficient of resources.
6. The nature of this seamer design commonly requires removal of the entire part to rotate or replace seaming rolls and bearings. This then requires adjustments of this pin component to ensure proper positioning. This results in costly downtime, this can be critical during “pack” or the primary canning season.
7. The pin tends to wear over about a third to a half of the projection 9c. This is because the seamer tool makes contact with a can lid and press to form the seam in a defined position, and wear will be on the side used to drive the roll assembly 21. When projection 9c is worn, the pin must be replaced. As described in section 6 above, any such replacement will result in system downtime.

An improved tool that addresses one or more of these aspects is desired.

### SUMMARY

The embodiments include a pin and double profile roll assembly. This assembly includes a pin that is mountable on a can sealing machine by means of a mounting projection. On an opposite side of the pin is a roller side projection. Between the roller side projection and the mounting projection is an annular disc having a peripheral disc lip forming a platform between the peripheral disc lip and the roller side projection. The pin has a hollow interior space which may be filled with grease. A passage through the roller side projection allows this grease to move to lubricate parts positioned proximate to the roller side projection.

On the platform is positioned a thrust bearing having horizontal rollers. Also included may be one or more washers positioned on one or more sides of the thrust bearing. A a roller bearing having vertical rollers mounted coaxial with said roller side projection. A seaming roll, is also mounted coaxial with the roller bearing, such that the roller side projection is central, the roller bearing is coaxially outer of the roller side projection and the reaming roll is coaxially outer of the roller bearing. A roller bearing is any device including rolling structures that is a single piece having rolling structures on that correspond to both sealing sides of a double sided seaming roll. Thus a single roller bearing replaces two bearing rings. A cap fits over the end of the seaming roll and a screw secures the cap on the roller side projection.

This device may also include a sealing ring positioned between the double sided seaming roll and the lip on the platform. This would prevent water or other liquid from reaching the thrust bearing and the sealing ring.

The screw may include a resilient button to prevent the screw from backing out during use.

### BRIEF DESCRIPTION OF THE DRAWINGS

FIG. 1 is an exploded view of a prior art seamer tool roll assembly.

FIG. 2 is an exploded view of an embodiment of an improved seamer tool roll assembly.

FIG. 3 is a cross sectional view of the assembled embodiment of FIG. 2.

FIG. 4 is a rear perspective view of the pin component.

FIG. 5 is a rear perspective view of the roller bearing sleeve.

FIG. 6 is a perspective view of the thrust bearings.

FIG. 7 is a perspective view of the roller bearings.

FIG. 8 is a perspective view of the seaming roll.

FIG. 9 is a bottom view of the bottom cap.

FIG. 10 is a perspective view of the flat headed socket cap screw.

FIG. 11 is a top perspective view of a parts tray.

FIG. 12 is a top perspective view of a parts tray showing the lid halves, with one lid half opened and the other closed.

FIG. 13 is an exploded view of an alternative embodiment of a seamer tool roll assembly.

FIG. 14 is a view of the seamer tool roll assemblies mounted on a can sealing machine.

### DETAILED DESCRIPTION

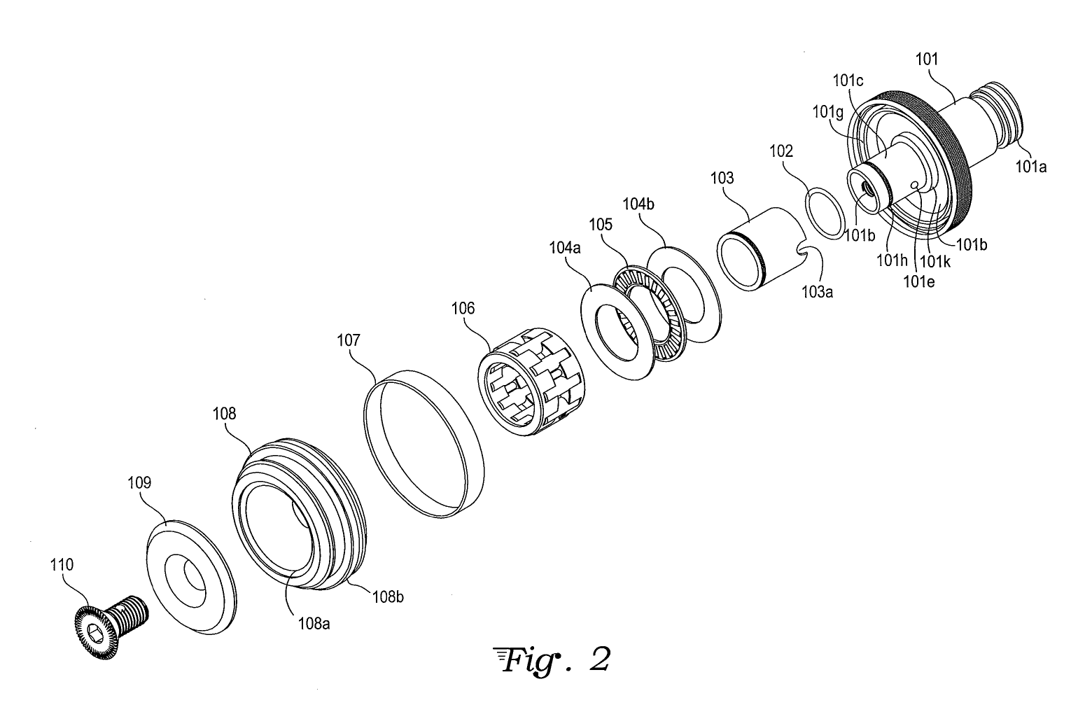

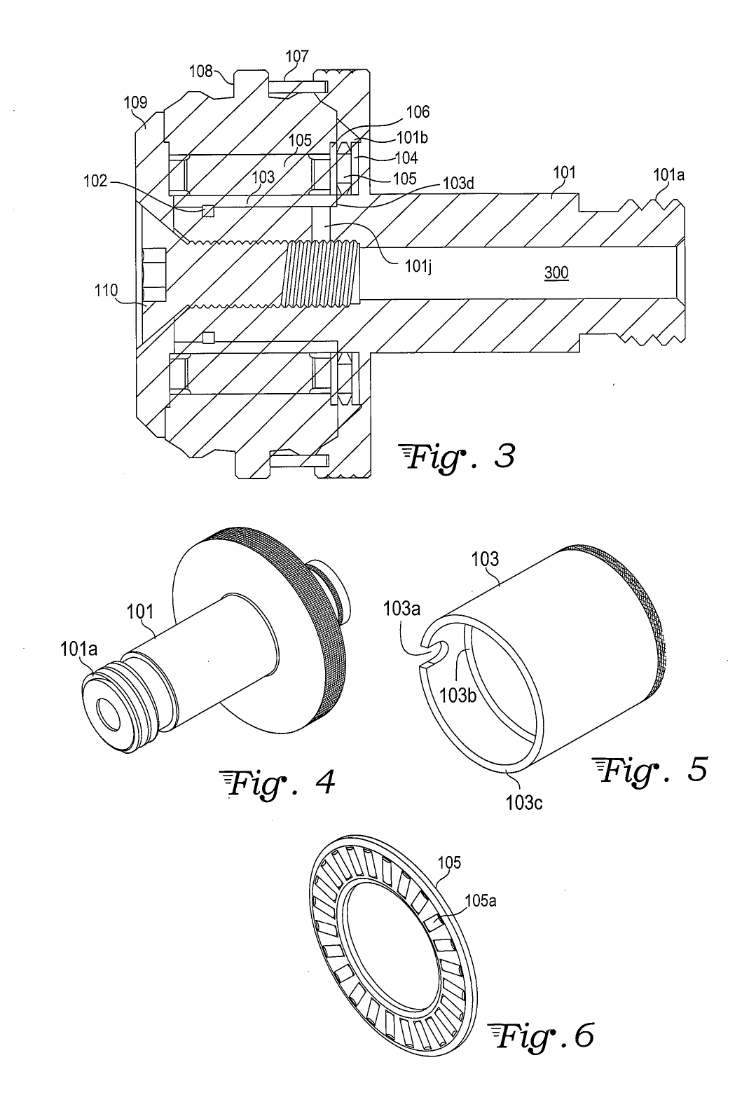

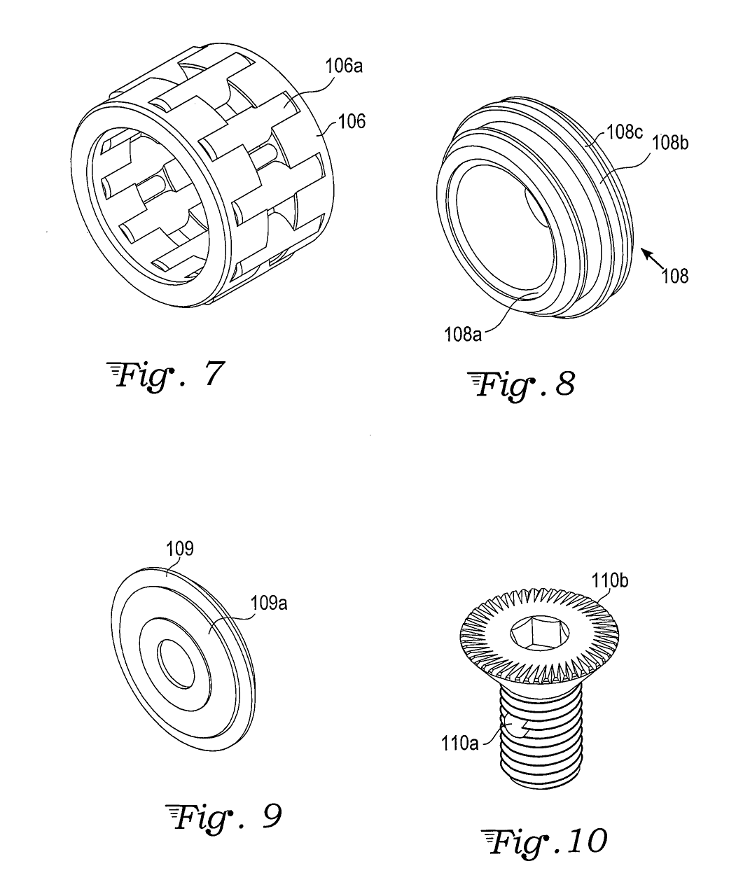

With reference to FIG. 2, the embodiment shows a main pin 101. As with existing pins, one end has threads 101a (as seen in FIG. 4) which allow attachment to the seamer tooling. Threads are one example of a fin fastening mechanism used to attach the pin to canning machinery. A projection 101c extends downward when the pin is mounted. The projection 101c includes an annular groove 101h. Onto groove 101h an O-ring 102 is mounted. In this embodiment roller bearing sleeve 103 is fit only projection 101c. As with prior roller a grease hole 101e extends into the interior of the projection 101c.

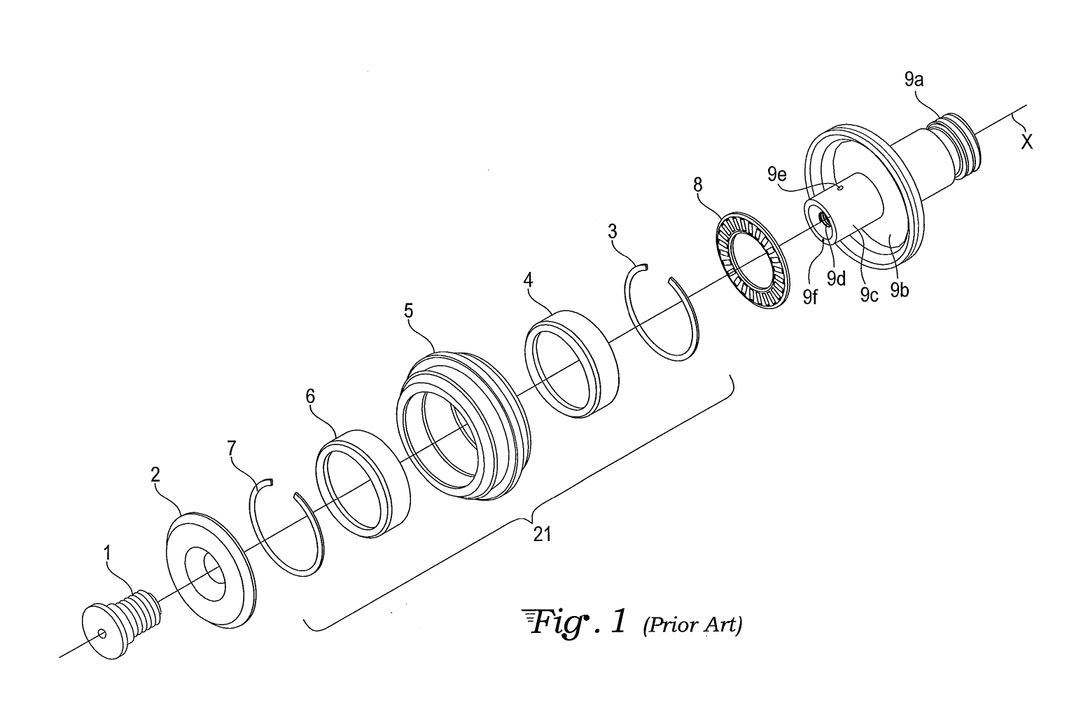

As shown in FIG. 3, the interior area 300 of the pin 101 is hollow. This allows this interior to be filled with lubricating grease. This grease is able to move in the pathway from interior space 300 to channel 101j, into a gap created by sleeve 103. As seen in FIG. 5, sleeve 103 includes an interior lip 103b. This creates a cylindrical space between sleeve 103 and projection 101c when the bottom 103c of sleeve 103 rests on lip 101k of the pin 101. In FIG. 3, the cylindrical space is shown as 103d. Grease can move from within the main pin in space 300, through channel 101j, into space 103d. Sleeve 103 is frictionally held by o-ring 102 on pin 101. In FIG. 5, sleeve grease notch 103a provides a lower opening to allow grease flow to the other parts retained on platform 101b (shown in FIG. 2). This positioning allows improved lubrication of thrust bearing 105 and roller bearing 106 (seem in FIGS. 1 and 3).

Again with reference to FIGS. 1 and 3, The grease hole 101e and grease channel 101j may be slightly closer to platform 101b than in existing roller pin parts. This allows screw 110 to be longer than in prior devices without impacting the flow of grease from the interior of projection 101c through grease hole 101e. Roller bearing sleeve 103 is retained frictionally by o-ring 102 on projection 101c held in channel 101h on projection 101c. As seen in FIG. 5, the roller bearing sleeve has a recessed lower interior area and a grease notch 103a. When roller bearing sleeve 103 is attached over projection 101c and frictionally retained on o-ring 102, the grease will flow from the interior of pin 101, through grease hole 101e, into the recessed lower interior area of roller bearing sleeve 103 and out grease notch 103a. This further lowers the location where grease is dispensed. Grease then may flow to lubricate both thrust bearing 105 and roller bearing 106.

Seated onto annular platform 101b on pin 101 are washer 104b, thrust bearing 105 and second washer 104a. Positioned on top of second washer 104a and fit frictionally over roller bearing sleeve 103 is roller bearing 106. Over roller bearing 106 is fit seaming roller 108. Capping the device is bottom cap 109, which (as seen in FIG. 9) has a raised seating lip 109a (opposite side as that shown in FIG. 2) which allows the cap 109 to be easily seated into seaming roll 108 in lip 108a as seen in FIG. 8. The socket cap screw 110 is secured into internal threads 101d on projection 101c.

Cap screw 110 is seen in detail in FIG. 10. This screw, as noted, may be a bit longer due to the positioning of the grease hold on the pin projection. The screw also has a number of additional useful features:

1. One or more side buttons 110a have been added to the threaded side, impeding screw back out during use.

2. The top of the screw has a face knurl 110 b, providing a finger grip surface.

3. The end of the screw is precision machined, with an angle to allow simplified seating into the projection on the internal threads 101d.

Returning to FIGS. 1 and 3, a cast nylon (or other material (e.g. polymer) that has similar thermal stability properties forms a grease seal ring 107 that fits between the seaming roll 108 and the pin 101. The pin has a downwardly extending vertical wall (shown in FIG. 4) which retains the grease seal ring 107. The seaming roll 108 has a shape that allows ring 107 to seal against seaming roll 108, frictionally fitted below the center band 108b. When bottom cap 109 is secured by cap screw 110, the seaming roll 108 is effectively sealed. When the part is washed, water will not be able to enter the assembly and will not be able to reach thrust bearing 105 and roller bearing 106. This will inhibit the roller bearing and thrust bearing from rusting.

The device and the device components have a number of features which could be viewed as improvements over existing technology. These include, but are not limited to:

1. The positioning of the grease dispensing hole 101e allows the grease to flow to both the thrust bearing 105 and the roller bearing 106. The grease notch 103a is positioned such that the first washer holds the thrust bearing 105 at a level at or above the bottom of the grease notch 103a in roller bearing sleeve 103. The upper part of grease notch allows grease to flow to roller bearing 106. Grease thus reaches both thrust bearing 105 and roller bearing 106 as the part is in use.

2. The top of the projection 101c and the roller bearing sleeve can be marked with top scribe marking. The roller bearing then can be periodically rotated. This allows more even wear, extending the life of the part. Further, the roller bearing can be replaced, without removal of the pin. This saves considerable time that could be needed for pin replacement and adjustment.

3. The roller bearing is slip fit into the seaming roll 108. Exchange of this part simply requires removal of the cap screw 110 and bottom cap 109. In fact, replacement of the washers 104, the thrust bearing 105, the roller bearing 103, or even the bottom cap and seaming roll are all rapid changes.

4. The grease ring 107 could be adapted to any other device including a pin and roller. The frictional fit of the ring on the seaming roll (or other rolling element) and the main pin 101 allows the part to be washed (as periodically required when working with liquid food that could spill or machinery that could have contaminants).

5. The height of the cap 109 will position roller bearing sleeve 106 into position by a frictional fit.

6. The screw has a unique design, inhibiting the screw from backing out. This allows a shorter screw to be used. This in turn, allows placement of the grease channel in a more advantageous position. In addition, the cap no longer needs a locating pin to prevent cap rotation.

7. Through the use of the improved device, the main pin has no wearable services. It may be designed for long life and be a corrosion resistant part. A stainless steel roller bearing sleeve bears the wear.

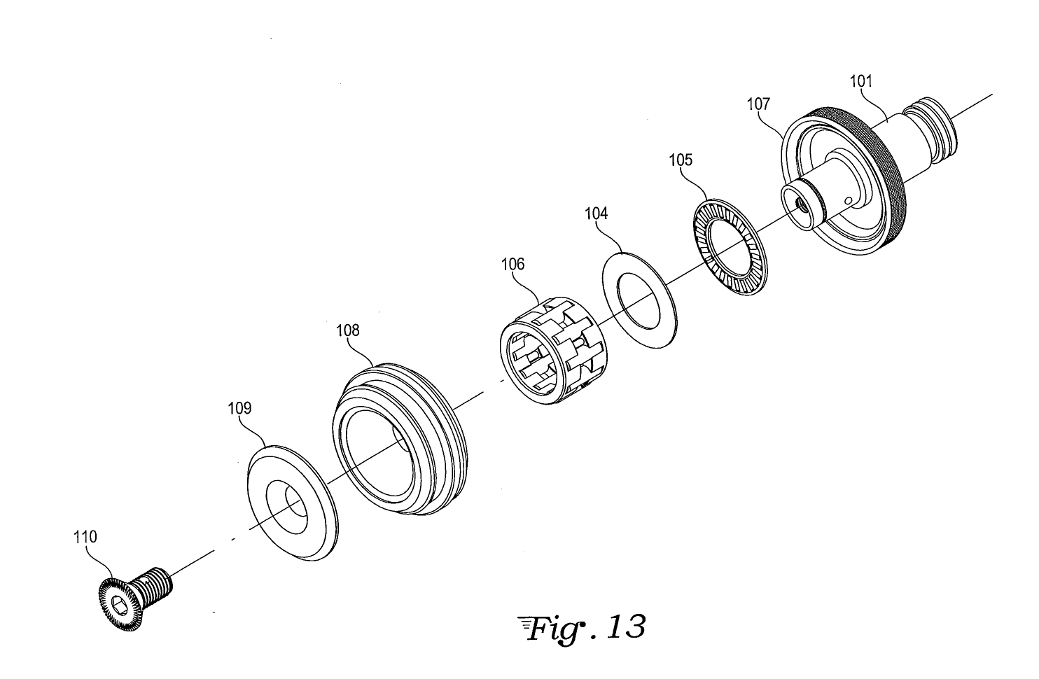

An alternative configuration is shown in FIG. 13. This configuration requires fewer parts, namely has eliminated one washer and the sleeve. The device still includes sealing ring 107, that is frictionally fit into a lip on pin 101 and fit onto seaming roll 108. This acts, as in the other embodiment, to inhibit water from reaching the thrust bearing 105 and the roller bearing 106 while the part is being cleaned. It also prevents more corrosive material (such as acidic liquids) that are being canned, from reaching these parts.

As in the prior embodiment, pin 101 holds the thrust bearing 105 and washer 104. Positioned against washer 104 and over the pin projection is the roller bearing 106. Positioned over the roller bearing is seaming roll 108. A cap 109 fits over seaming roll 108 and a screw 110, screwed into the internal threads of a projection on the pin 101 holds all of these parts in place.

One major advantage of the present device is that essentially all of the components may simply and easily be changed without removal and readjustment of the pin. These can be changed out quickly and without need of specialized tools (such as a press, vice, etc.)

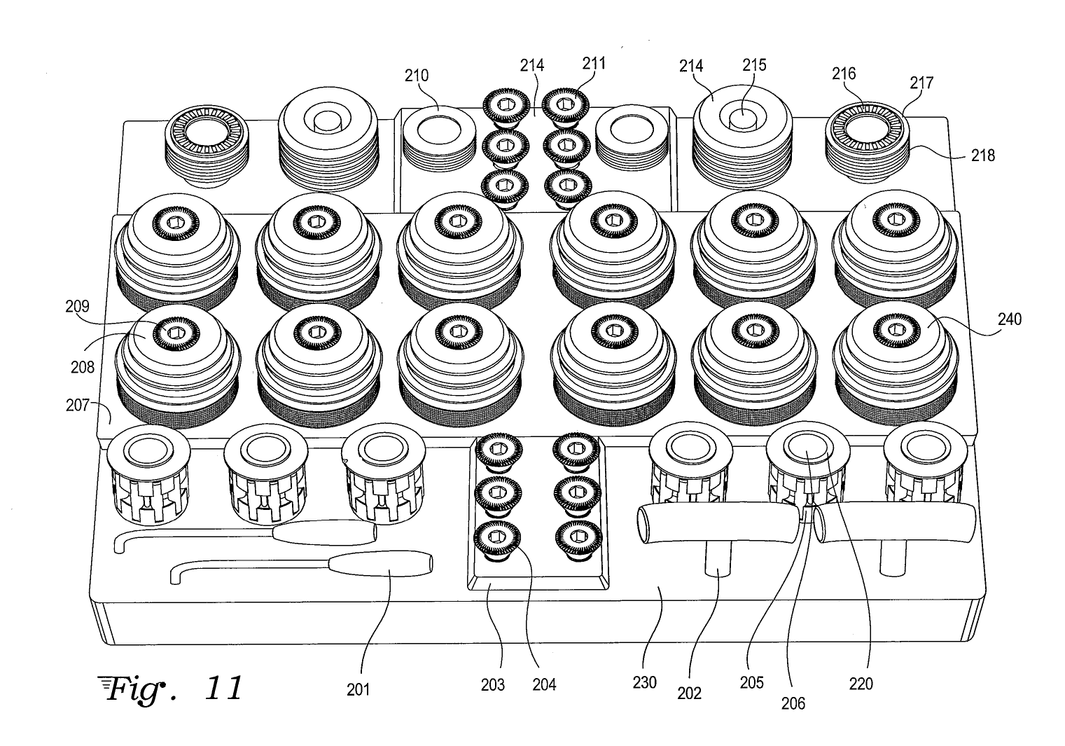

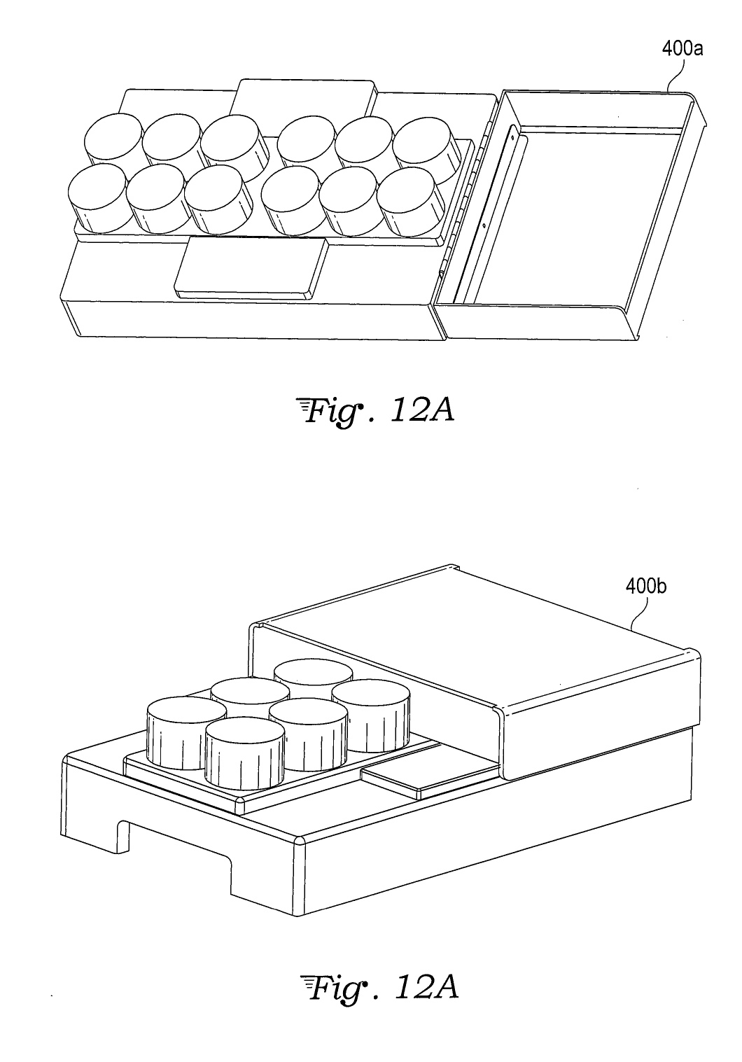

FIGS. 11 and 12 show a tray holding parts for the present system. As noted, the present rollers make the replacement of parts much simpler, adding greater life to the part. The present tray allows a unique organization of the parts, providing in one package a full set of parts and tools for replacement.

With reference to FIG. 11, the tray includes a tray base holding a number of posts 206, 215, 216. Mounted on the tray base is a long platform 207 extending substantially the length of the tray. A number of holes (not shown) on this long platform allow the platform to hold a number of fully assembled roll assembly devices, such as a first operation roll assembly 208 having a screw 209 and the second roll assembly 240. One half of the tray will hold parts specific to the first operation roll assembly device and the second half of the tray will hold parts specific to the second operation roll assembly device. This allows a worker an easy organization of the parts.

On one side of the tray on tray base 230 held on a post, such as post 206 are roller bearing sleeve 220 and roller bearing 205. The post is sufficiently tall to hold two roller bearing sleeves and two roller bearings. Thus the three posts shown hold six of each parts.

On one side of the tray is a raised screw platform holding screws 204. The six screws may be used for either first operation or second operation roller assemblies.

On the opposite side of the tray is a raised platform 212 that holds screws 211 and holder 210, which is described below.

Flanking raised platform 212 are two posts on each side. Post 215 is shown holding bottom cap 214. Post 216 holds 12 thrust washers 218 and 6 thrust bearings 217. Thus the five posts on each half of the tray holds sufficient parts to replace the thrust bearings and washers, roller bearings and roller bearing sleeves and bottom cap on each of the six roller bearing assemblies on that half of the tray. This is useful, as the roller bearing assemblies each have a two sided seaming roll. The raised platforms mounted on a tray base, with the base having posts holding stacked parts, allow all of the parts to have substantially the same top level (within the width of the thinnest part). This allows a tray cover to enclose the parts. The parts, so enclosed, are unlikely to fall off their holder and become disorganized. The tray also holds T wrench 202 and L wrench 201. These allow a user to remove the screws. The wrenches are fitted into holes on tray base 230.

FIG. 12 show the lid of the tray open and closed. The inside of the lid may include instructions as to the assembly of the roller parts and other useful information.

Holder having a threaded end 210 has a knob end (shown) which is slightly smaller in diameter than the roller bearings. The other end is a threaded end having the same diameter as the screws (e.g. screw 211). During maintenance of the roller assemblies, the screw may be removed and the bottom plate and seaming roll and sealing ring removed. The holder 210 would retain the roller bearing, roller bearing sleeve, thrust bearing washers and thrust bearing on the main pin on the canning machine. This allows rotation of the roller bearing to check for wear or improper operation. This visual inspection was not available before. If operation appears satisfactory, the sealing ring, seaming roll, bottom cap and screw can be replaced.

The tray provides an organized and transportable set of replacement parts, includes the tools for changing parts, and an additional part useful for inspection of the rollers.

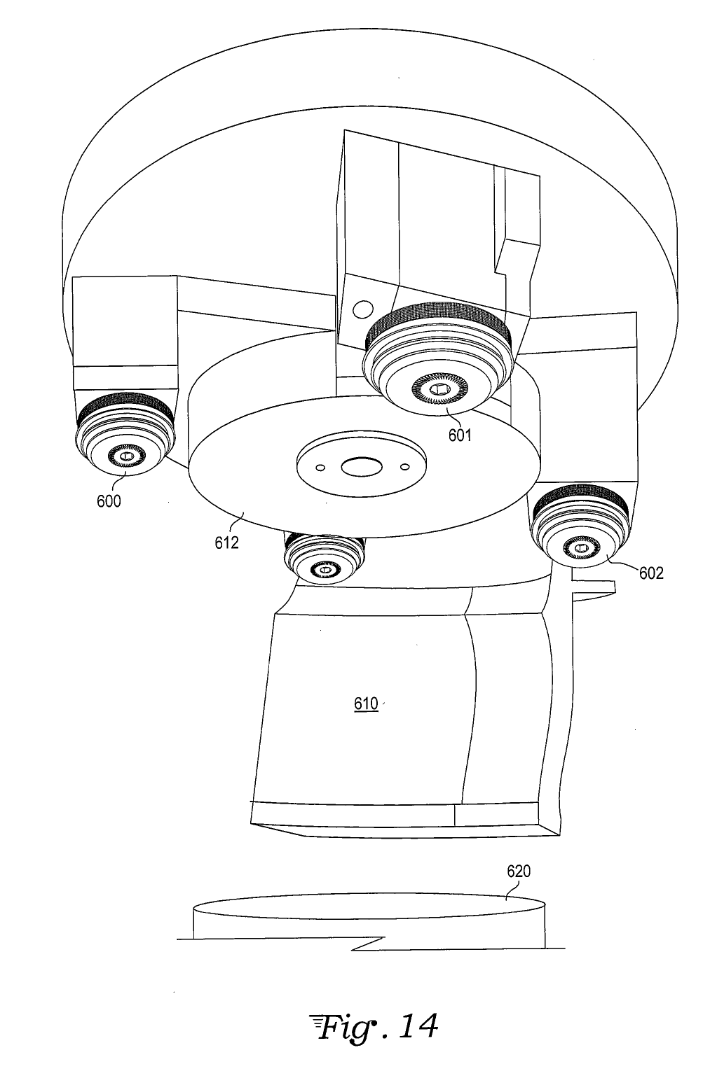

FIG. 14 shows three pins and double roll assembly on a can sealing machine. The three pins and double roll assembly parts, 601, 602 and 603, are positioned such that the rollers can contact a lid held on plate 612 when a can (not shown) is positioned at curved wall 610, with a bottom resting on platform 620. The pins are rotated about the can, sealing the can lid.

What is claimed is:

1. A pin and double profile roll assembly comprising;
a pin having a mounting projection, an opposing roller side projection, and an orthogonal annular disc positioned between said mounting projection and opposing roller side projection, said annular disc having a peripheral disc lip forming a platform between the peripheral disc lip and the roller side projection, said mounting projection having an interior grease passage accessible through an open end on said mounting projection, said grease passage extending through the roller side projection;
a thrust bearing having horizontal rollers positioned proximate to said platform;
a roller bearing having vertical rollers mounted coaxial with said roller side projection;
a seaming roll, mounted coaxial with the roller bearing, such that the roller side projection is central, the roller bearing is coaxially outer of the roller side projection and the reaming roll is coaxially outer of the roller bearing;
a cap fitting over an end of the seaming roll, and
a screw securing the cap onto the roller side projection, thereby retaining the seaming roll and roller bearing on the roller side projection.

2. The device of claim 1, further comprising a sealing ring positioned between the seaming roll and the peripheral disc lip of the platform, such that liquid is prevented from access to the thrust bearing and roller bearing when the device is washed.

3. The device of claim 1, wherein said screw includes a resilient side button on a screw thread surface, said button positioned such that it inhibits said screw from backing out as the device is rotated.
